(19) United States
(12) Patent Application Publication
(10) Pub. No.: US 2007/0227920 A1
(43) Pub. Date: Oct. 4, 2007

(54) Case for Holding Storage Media, its Production and its Use

(75) Inventor: Manfred Hinkelmann, Kalkar (DE)

Correspondence Address: K.F. ROSS P.C., 5683 RIVERDALE AVENUE, SUITE 203 BOX 900, BRONX, NY, 10471-0900, US

(73) Assignee: FUJI MAGNETICS GMBH, Kleve (DE)

(21) Appl. No.: 10/555,254

(22) PCT Filed: Dec. 22, 2004
(86) PCT No.: PCT/EP04/14607

§ 371 Date: Nov. 1, 2005

(51) Int. Cl. G11B 23/22

(52) U.S. Cl. 206/307; 29/592

(57) ABSTRACT

This document discloses a case for holding storage media, particularly data cassettes, having a top part and a bottom part that are joined to each other, whereby at least one section, preferably four sections, is/are provided inside the case in order to hold at least two storage media, preferably four to twenty storage media.

### CROSS REFERENCE TO RELATED APPLICATIONS

This application is the US national phase of PCT application PCT/EP2004/014607 filed 22 Dec. 2004 with a claim to the priority of PCT patent application PCT/EP2004/014607 itself filed 22 Dec. 2004.

The present invention relates to a case for holding storage media, especially data cassettes, to its production and to its use.

German utility model DE-U 8613067 discloses a filing case for magnetic tape cassettes with foldable parts, whereby a case compartment that can be folded twice is provided which, on one face, has a rim on two sides at the level of the bottom of the case compartment and said case compartment comprises two adjacent stacks, each having at least two stack inserts open towards the top and designed to hold magnetic tape cassettes. This prior-art filing case, however, has the drawback that the closure mechanism is complex and the filing cases cannot be stacked on top of each other, and also that it does not sufficiently protect the contents of the case against dust, moisture, splashed water and optionally even against water.

Furthermore, storage media, especially data cassettes in horizontally and vertically stackable and expandable media boxes with an ejection mechanism, are offered on the market. However, such solutions, which hold, for example, a maximum of nine VHS cassettes, are very expensive and have a complex design. In this context, we make reference to products of this type in the Conrad main catalog 2004, page 112, which are offered by the Posso company.

The present invention has the objective of creating an innovative case for holding storage media, especially data cassettes, which is easy to handle in actual practice and which can be transported in a vertical as well as horizontal position.

The objective of the present invention is achieved by means of a case according to the main claim. Therefore, the present invention relates to a case 1 for holding storage media, particularly data cassettes, having a top part 2 and a bottom part 3 that are joined to each other, whereby at least one section, preferably four sections 5, is/are provided inside the case 1 in order to hold at least two storage media, preferably four to twenty storage media.

The term storage media as employed in the present invention refers to audio cassettes and dictation cassettes, video cassettes as well as data cassettes, especially data cartridges. Moreover, these cases can also be employed to store other magnetic or optomagnetic data carriers such as CD-ROMs and DVDs.

In accordance with a preferred embodiment, the case according to the invention has two or more sections with partitions between the sections.

In accordance with another preferred embodiment, the case according to the invention has numerous outside walls that form an outer rim, a cover section 6 and a floor section 7, each of which is affixed to the outside walls.

According to another preferred embodiment, the top part 2 and the bottom part 3 are releasably joined by an edge 8 that runs outside of the outside walls.

According to another preferred embodiment, the top part 2 is releasably joined to the bottom part 3 by means of at least one tongue 9 and groove 10 joint that especially encircles the edge 8.

According to another preferred embodiment, the top part 2 has a groove 10 and the bottom part 3 has a tongue 9, or else the top part 4 and the bottom part 3 have a groove 10 and a tongue 9.

According to another preferred embodiment, the top part 2 with the groove 10 and the tongue 9 is identical to the bottom part 3.

According to another preferred embodiment, the edge 8 has at least one opening 11 that serves as a handle or as a wall fastener. This configuration of the opening as a handle or wall fastener ensures optimal transportation or vertical storage of the case 1 according to the invention.

According to another preferred embodiment, at least one element 12 is arranged outside of the case 1 on the bottom section 7 and on the cover section 6, said element allowing the case 1 to be releasably joined to a case located above and/or below it.

According to another preferred embodiment, the element 12 of one case 1 is at least one journal 13 and/or at least one slit 14 that engages with the corresponding elements 13, 14 of the next case.

According to another preferred embodiment, the journal 13 has a round or essentially rectangular shape, especially the rectangular shape of a circular ring with rounded-off corners, that engages into a round or essentially rectangular slit 14, especially the rectangular shape of a circular ring with rounded-off corners, having a correspondingly larger diameter.

Another preferred embodiment comprises a case with two or four sections 5, 5′, 5″, 5′″, with a top part 2 that has a groove 10 and a bottom part 3 that has a tongue 9, with two openings 11 in the edge 7 that serve as a handle or wall fastener and elements 13, 14 that serve to join the cases to each other.

According to another preferred embodiment, the case comprises wear-resistant thermoplastics and/or corresponding recycled materials. For instance, polyethylene terephthalate (PET) or corresponding recycled polyethylene terephthalate can be employed for this purpose.

The present invention also relates to storage media packaging, especially for data cassettes (=data backup tapes), comprising the case 1 according to claims of the above-mentioned type, together with storage media, especially data cassettes (=data backup tapes).

The present invention also relates to a production process for the case according to the invention.

The present invention also relates to the production of the above-mentioned cases for holding storage media, characterized in that the top part and the bottom part are made in a familiar manner by means of thermoplastic shaping methods, particularly injection molding or deep drawing, and both parts are releasably joined to each other, especially by means of a tongue-and-groove joint. The top and bottom parts are made either out of a thermoplastic prepeg by means of shaping or else directly from the appropriate master batch.

Finally, the present invention relates to the use of the case according to the invention. Lastly, the subject matter of the present invention is the use of the case according to the invention in order to store, archive and transport storage media, especially data cassettes.

The present invention will now be explained in greater detail with reference to four figures. For the sake of greater clarity, reference is hereby made to the following list of reference numerals:
1 case
2 top part
3 bottom part
4 storage media
5 section
6 cover section
7 floor section
8 edge
9 tongue
10 groove
11 opening
12 element
13 journal
14 slit

The following is shown:

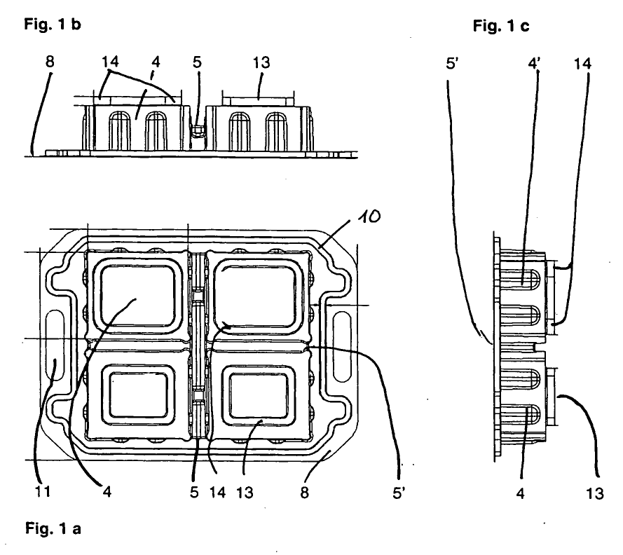

FIG. 1—the top part of the case according to the invention, in a top view (FIG. 1a), in a front view (FIG. 1b) and in a side view (FIG. 1c);

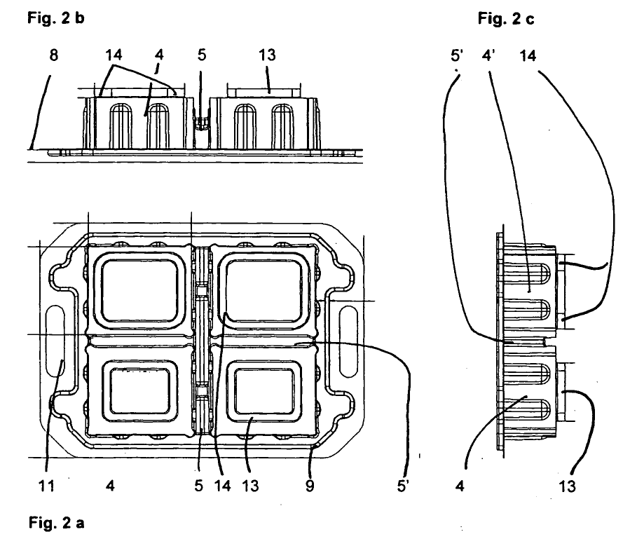

FIG. 2—the bottom part of the case according to the invention, in a top view (FIG. 2a), in a front view (FIG. 2b) and in a side view (FIG. 2c); and

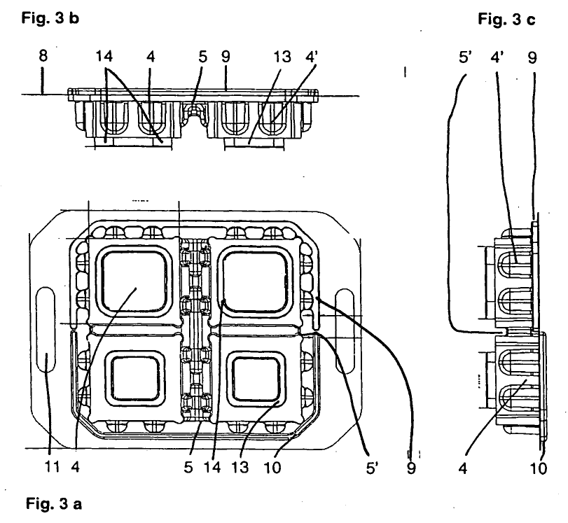

FIG. 3—as an alternative embodiment, a part that can be employed both as a top part and as a bottom part of the case, in a top view (FIG. 3a), in a front view (FIG. 3b) and in a side view (FIG. 3c).

FIG. 1 depicts a case 1 for holding data cassettes 4 that has sections 5 arranged inside of the case 1. The edge 8 with its opening 11 is also shown there. Likewise visible are the groove and the typical journal-slit connection feature that allows the cases to be stacked on top of each other.

FIG. 2, depicting the bottom part 3, likewise shows sections 5 for holding storage media 4; the edge 8 with the opening 11 can likewise be seen there. Here, too, the joining element, the tongue 9, is likewise depicted as well as the joining elements that join the cases to each other, namely, the journal 13 and slit 14.

The case assembled from the top part according to FIG. 1 and the bottom part according to FIG. 2—which can be firmly joined to each other by being pressed together—can securely protect the storage media, especially data cartridges that are placed in them, against dust, moisture, splashed water and other harmful substances. This box can even be classified as water-proof and a fully filled and properly sealed box can float in water, as has been demonstrated by testing conducted by the applicant.

FIG. 3 likewise shows sections 5 for holding storage media 4 that have an encircling edge 8 that is provided with openings 11. Moreover, FIG. 3 shows the tongue 9 and groove 10 joint that creates an individual case as well as the journal 13 and slit 14 connection that joins several cases together. Owing to the fact that the top and bottom parts are the same, such a case can be manufactured even more cheaply than the case made of two elements according to FIGS. 1 and 2. This case type according to the alternative embodiment of the present invention—once it has been put together with two elements—also provides good protection of the storage media against dust, moisture, splashed water and other harmful substances, although complete water-tightness no longer exists in this case.

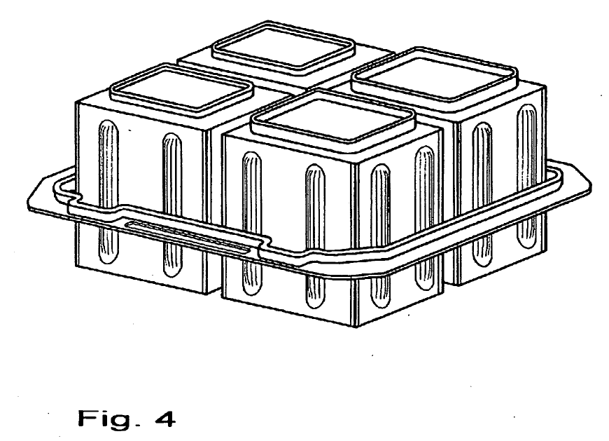

FIG. 4 shows the case 1 according to the invention in its closed state, as it is obtained by joining either the top part according to FIG. 1 and the bottom part according to FIG. 2, or else by joining two units of the part according to FIG. 3 with the tongue-and-groove joint; as shown by way of an example, said case has 20 data cartridges in a configuration consisting of 4×5 units.

1. A case (1) for holding storage media, particularly data cassettes, having a top part (2) and a bottom part (3) that are joined to each other, whereby at least one section, preferably four sections (5), is/are provided inside the case (1) in order to hold at least two storage media, preferably four to twenty storage media.

2. The case according to claim 1, characterized in that it has two or more sections (5′, 5″) with partitions between the sections.

3. The case according to claim 1, having numerous outside walls that form an outer rim, a cover section (6) and a floor section (7), each of which is affixed to the outside walls.

4. The case according to claim 3, characterized in that the top part (2) and the bottom part (3) are releasably joined by an edge (8) that runs outside of the outside walls.

5. The case according to claim 4, characterized in that the top part (2) is releasably joined to the bottom part (3) by means of at least one tongue (9) and groove (10) joint that especially encircles the edge (8).

6. The case according to claim 1, characterized in that the top part (2) has a groove (10) and the bottom part (3) has a tongue (9), or else the top part (2) and the bottom part (3) have a groove (10) and a tongue (9).

7. The case according to claim 5, characterized in that the top part (2) with the groove (10) and the tongue (9) is identical to the bottom part (3).

8. The case according to claim 4, characterized in that the edge (8) has at least one opening (11) that serves as a handle or as a wall fastener.

9. The case according to claim 1, characterized in that at least one element (12) is arranged outside of the case (1) on the bottom section (7) and on the cover section (6), said element allowing the case (1) to be releasably joined to a case located above and/or below it.

10. The case according to claim 9, characterized in that the element (12) of one case (1) is at least one journal (13) and/or at least one slit (14) that engages with the corresponding elements (13, 14) of the next case.

11. The case according to claim 10, characterized in that the journal (13) has a round or essentially polygonal shape, especially the rectangular shape of a circular ring with rounded-off corners, that engages into a round or essentially polygonal slit (14), especially the rectangular shape of a circular ring with rounded-off corners, having a correspondingly larger diameter.

12. The case according to claim 1,
with two or four sections (5, 5′, 5″, 51,
with a top part (2) that has a groove (10) and
a bottom part (3) that has a tongue (9),
with two openings (11) in the edge (7) that serve as a handle or wall fastener,
and elements (13, 14) that serve to join the cases to each other.

13. The case according to claim 1, characterized in that it comprises wear-resistant thermoplastics and/or corresponding recycled materials.

14. Storage media packaging, especially for data cassettes, comprising the case (1) according to the above-mentioned claims, together with storage media, especially data cassettes.

15. A method for the production of the case for holding storage media, especially data cassettes, characterized in that
the top part and the bottom part are made in a familiar manner by means of thermoplastic shaping methods, particularly injection molding or deep drawing,
and both parts are releasably joined to each other, especially by means of a tongue-and-groove joint.

16. Use of the case according to claim 1 in order to store, archive and transport storage media, especially data cassettes.
